(19) United States
(12) Patent Application Publication
(10) Pub. No.: US 2023/0416045 A1
(43) Pub. Date: Dec. 28, 2023

(54) APPARATUS AND METHOD FOR MANAGING CALLING UNITS AND ELEVATOR SYSTEM

(71) Applicant: Otis Elevator Company, Farmington, CT (US)

(72) Inventors: Yu Zhang, Shanghai (CN); Shenhong Wang, Shanghai (CN)

(21) Appl. No.: 18/070,041

(22) Filed: Nov. 28, 2022

(30) Foreign Application Priority Data
Jun. 8, 2022 (CN) 202210640066.1

(51) Int. Cl. B66B 1/34; B66B 1/46

(52) U.S. Cl. CPC B66B 1/3446; B66B 1/468

(57) ABSTRACT

An apparatus for managing a plurality of call-out units includes: a processor; and memory and storing configuration information about the plurality of call-out units and computer program capable of running on the processor, the plurality of call-out units are deployed on a plurality of floors, the running of the computer program on the processor causes: A. powering on the plurality of call-out units in sequence according to a preset floor order to cause the plurality of call-out units to return response messages containing their respective identifications in sequence; and B. if a response message received from a call-out unit of one of the floors does not contain an identification, assigning a corresponding identification to the call-out unit and establishing a binding relationship between the floor to which the call-out unit belongs and the identification as assigned in the configuration information.

### FOREIGN PRIORITY

This application claims priority to Chinese Patent Application No. 202210640066.1, filed Jun. 8, 2022, and all the benefits accruing therefrom under 35 U.S.C. § 119, the contents of which in its entirety are herein incorporated by reference.

### TECHNICAL FIELD

The present application relates to elevator technology, in particular to an apparatus and a method for managing a plurality of call-out units, an elevator system comprising the apparatus, and a computer-readable storage medium on which computer program for implementing the method is stored.

### BACKGROUND

An elevator system contains a plurality of call-out units installed at each floor or landing station. These call-out units receive a call request from a passenger and subsequently send a message about the call request to an elevator controller or a control cabinet, which generates a dispatching command of an elevator based on the received message.

Before the elevator system is put into use, the call-out units need to be configured, such as establishing a binding relationship between the floor to which the call-out unit belongs and its identification. Currently, the configuration operation needs to be done manually on site. This operation is very time-consuming and labor-intensive, especially for the elevator system in a large number of high-rise and super high-rise buildings, because the call-out units are located at multiple floors.

### SUMMARY

According to an aspect of the present application, there is provided an apparatus for managing a plurality of call-out units, wherein the apparatus comprises a control unit, the control unit comprising: a processor; and memory coupled with the processor and storing configuration information about the plurality of call-out units and computer program capable of running on the processor, wherein the plurality of call-out units are deployed on a plurality of floors, wherein the running of the computer program on the processor causes: A. powering on the plurality of call-out units in sequence according to a preset floor order to cause the plurality of call-out units to return response messages containing their respective identifications in sequence; and B. if a response message received from a call-out unit of one of the floors does not contain an identification, assigning a corresponding identification to the call-out unit and establishing a binding relationship between the floor to which the call-out unit belongs and the identification as assigned in the configuration information.

Optionally, in the above apparatus, the running of the computer program further causes: C. returning the identification as assigned to the call-out unit of one of the floors.

Optionally, in the above apparatus, in addition to one or more of the above features, the running of the computer program further causes: D. if no response message is received from the call-out unit of one of the floors and a corresponding identification exists for the floor in the configuration information, releasing a binding relationship between the floor and the corresponding identification in the configuration information.

Optionally, in the above apparatus, in addition to one or more of the above features, the running of the computer program further causes: E. if the response message received from the call-out unit of one of the floors contains the identification, establishing a binding relationship between the floor to which the call-out unit belongs and the identification contained in the response message in the configuration information.

Optionally, in the above apparatus, in addition to one or more of the above features, the configuration information is presented in the form of a list, each item of the list is used to describe the binding relationship between the floor to which the call-out unit belongs and the identification of the call-out unit.

Optionally, the above apparatus is an elevator controller.

Optionally, in the above apparatus, operation A is performed during initialization of an elevator.

According to another aspect of the present application, there is provided an apparatus for managing a plurality of call-out units, wherein the apparatus comprises a control unit, the control unit comprising: a processor; and memory coupled with the processor and storing configuration information about the plurality of call-out units and computer program capable of running on the processor, wherein the plurality of call-out units are deployed on a plurality of floors, wherein the running of the computer program on the processor causes: A′. powering on the plurality of call-out units in sequence according to a preset floor order to cause the plurality of call-out units to return response messages containing their respective device identifications in sequence; and B′. establishing a binding relationship between the device identification contained in the corresponding response message and the floor in the configuration information for each floor.

Optionally, in the above apparatus, the running of the computer program further causes: C′. if no response message is received from the call-out unit of one of the floors and a corresponding device identification exists for the floor in the configuration information, releasing a binding relationship between the floor and the corresponding device identification in the configuration information.

Optionally, in the above apparatus, in addition to one or more of the above features, the configuration information is presented in the form of a list, each item of the list is used to describe the binding relationship between the device identification of the call-out unit and the floor to which the call-out unit belongs.

According to another aspect of the present application, there is provided an elevator system comprising the apparatus for managing a plurality of call-out units as described above.

According to another aspect of the present application, there is provided a method for managing a plurality of call-out units, comprising: A. powering on the plurality of call-out units in sequence according to a preset floor order to cause the plurality of call-out units to return response messages containing their respective identifications in sequence; and B. if a response message received from a call-out unit of one of the floors does not contain an identification, assigning a corresponding identification to the call-out unit and establishing a binding relationship between the floor to which the call-out unit belongs and the identification as assigned in configuration information.

According to another aspect of the present application, there is provided a method for managing a plurality of call-out units, comprising: A′. powering on the plurality of call-out units in sequence according to a preset floor order to cause the plurality of call-out units to return response messages containing their respective device identifications in sequence; and B′. establishing a binding relationship between the device identification contained in the corresponding response message and the floor in configuration information for each floor.

According to another aspect of the present application, there is provided a computer-readable storage medium on which computer program suitable for running on a processor of a terminal device is stored, the running of the computer program causes steps of the method as described above to be performed.

### DESCRIPTION OF THE DRAWINGS

The above and/or other aspects and advantages of the present application will be clearer and more easily understood from the following description of various aspects in conjunction with the accompanying drawings, in which the same or similar elements are denoted by the same reference numerals. The accompanying drawings include:

FIG. 1 is a flowchart of a method for managing call-out units in accordance with some embodiments of the present application.

FIG. 2 is a flowchart of a method for updating configuration information based on response messages in accordance with some other embodiments of the present application.

FIG. 3 is a flowchart of a method for managing call-out units in accordance with some other embodiments of the present application.

FIG. 4 is a schematic block diagram of a typical elevator controller or computing device.

FIG. 5 is a schematic block diagram of a typical elevator system.

### DETAILED DESCRIPTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

According to an aspect of the present application, the call-out units deployed on a plurality of floors are configured using a control apparatus or node device (e.g., an elevator controller or a control cabinet) independent of the call-out units. In particular, the control apparatus powers on the call-out units on each floor in sequence according to a preset floor order to cause the call-out units on each floor to return response messages; the control apparatus then completes configurations of the call-out units based on the response messages.

For the control apparatus, the above preset floor order is known, so the floor to which the configured call-out unit belongs can also be determined. The floor order herein should be broadly understood to include various orders, such as from top to bottom, from bottom to top, and odd-numbered floors followed by even-numbered floors. In addition, the plurality of floors described above may be all of the floors of a building, or some of the floors.

According to another aspect of the present application, the response message returned by the call-out unit may contain an identification (which has been assigned by the control apparatus) or not contain an identification (which has not been assigned by the control apparatus). The identification described herein should be broadly understood as various identification data assigned by the control apparatus that can distinguish one call-out unit from other call-out units. The control apparatus may perform corresponding configuration operation based on the response message. For example, if the response message does not contain an identification, the control apparatus assigns an identification to the call-out unit sending the message and records in the configuration information a binding relationship between the identification as assigned and the floor to which it belongs; for example, if the response message contains an identification, the control apparatus updates the identification already recorded in the configuration information to the identification contained in the response message; and for example, if no response message is received from an call-out unit, the control apparatus will release the binding relationship between the identification assigned to the call-out unit and the floor to which it belongs from the configuration information.

According to another aspect of the present application, the response message returned by the call-out unit may always contain device identification (e.g., MAC address, device number set before leaving the factory, etc.). The control apparatus may also perform the corresponding configuration operation based on the response message. For example, for each floor, the control apparatus records in the configuration information a binding relationship between the device identification contained in the response message and the floor.

According to another aspect of the present application, the configuration operation may be performed during initialization of an elevator system, and the initialization of the elevator system may be performed before the elevator system is first put into operation, or after the elevator system is put into operation to update the configuration information of the call-out unit (e.g., replacing a new call-out unit and switching the position of an existing call-out unit, etc.).

According to a further aspect of the present application, each call-out unit may be configured to automatically return the response message to the control apparatus upon power-up or power-on. In the above case, powering on the call-out unit is equivalent to sending an indication of returning the response message to it, so an explicit indication is unnecessary.

It should be noted that in the above case, when the call-out unit is powered on, the call-out unit that was previously powered on may be powered off or may remain powered on. In this document, the expressions of powering on or powering up in sequence should be understood to already cover these ways.

It should also be noted that communication between the control apparatus and the call-out unit can be realized by wireless means or wired means. As more and more elevators adopt call-out units with wireless communication capabilities, it will become advantageous to accomplish configuration operations by wireless means.

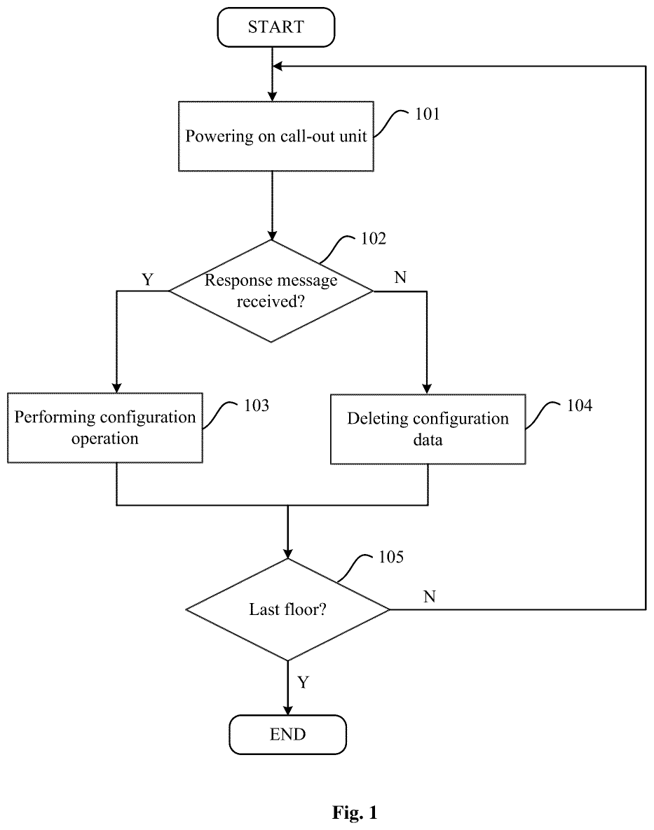

FIG. 1 is a flowchart of a method for managing call-out units in accordance with some embodiments of the present application. The method described below may be implemented by various control apparatuses that include, for example, but are not limited to, elevator controllers and other computing devices different from elevator controllers (e.g., portable computers and cell phones, etc.), etc.

Referring to FIG. 1, in step 101, the control apparatus selects the call-out unit (for example, denoted as HBᵢ) of the i-th floor Floori from a list of floors to be configured (for example, denoted as {Floorᵢ|i=1, 2 n}, exemplarily, the subscripted number represents the floor) according to a preset floor order (e.g., from bottom to top) to power on. As described above, each call-out unit may be configured to automatically return the response message to the control apparatus upon each power-up, the response message may or may not contain the identification about the call-out unit.

Subsequently, in step 102, the control apparatus determines whether the response message returned by the call-out unit HBᵢ is received. Exemplarily, the control apparatus determines whether the response message is received within a preset time period starting from power-on. If the response message is received, the configuration process shown in FIG. 1 proceeds to step 103, otherwise it proceeds to step 104.

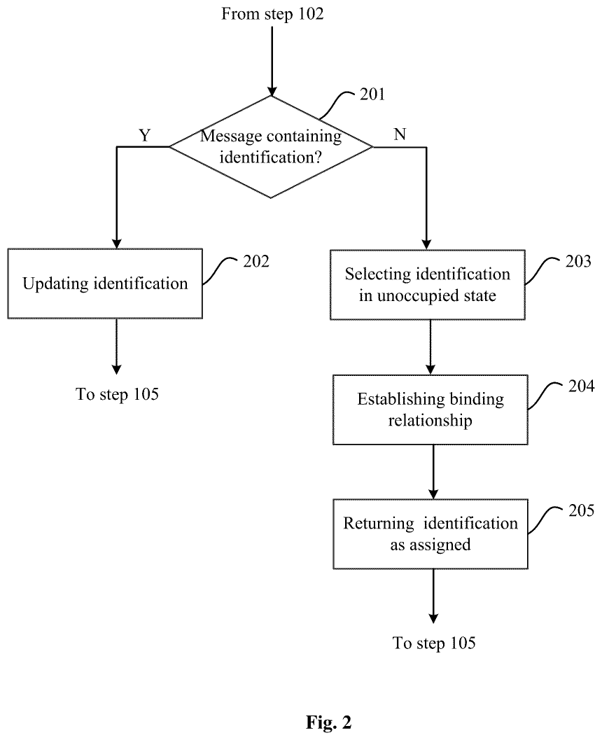

In step 103, the control apparatus determines whether the call-out unit HBᵢ has an associated floor based on the response message, and performs the corresponding processing step based on the determination result. The specific implementation of step 103 will be described in detail below with the help of FIG. 2.

In another branch step 104 of step 102, the control apparatus releases the binding relationship between the i-th floor and the corresponding identification by deleting the configuration data of the call-out unit HBᵢ in the configuration information.

In this embodiment, the configuration information stored at the control apparatus contains the binding relationship between the call-out unit and the corresponding floor. Exemplarily, the configuration information represents the binding relationship in the form of a list, for example, as shown in Table 1.

TABLE 1

| Table Item | Floor | Identification |
|---|---|---|
| 1 | 5 | A1 |
| 2 | X | A2 |
| . . . | . . . | . . . |
| j | I | Aj |
| . . . | . . . | . . . |
| m | X | Am |

In Table 1, each row can be used to indicate the binding relationship between the floor and the identification. The number in column of the table item indicates the row number, the number in column of the floor indicates the floor or the call-out unit of the floor (e.g., “5” indicates the 5th floor or the call-out unit HB₅ of the 5th floor), “X” indicates that the identification in the row is not yet assigned to the call-out unit, and A1-Am in column of the identification is a string indicating the identification assigned to the call-out unit.

In an example, it is assumed that the identification corresponding to the call-out unit HBi at the i-th floor in the configuration information is Aj as shown in Table 1 (i.e., the column of the floor in Table 1 is assigned with the string Aⱼ in row i), the control apparatus will delete the configuration data of the call-out unit HBᵢ when no response message is received from the call-out unit HBᵢ. The modified configuration information list is shown in Table 2, in which the floor in the row where the identification Aⱼ is located has been modified from “i” to X.

TABLE 2

| Table Item | Floor | Identification |
|---|---|---|
| 1 | 5 | A1 |
| 2 | X | A2 |
| . . . | . . . | . . . |
| J | X | Aj |
| . . . | . . . | . . . |
| M | X | Am |

After steps 103 and 104, the configuration process shown in FIG. 1 all goes to step 105, in which the control apparatus will determine whether the current floor Floorᵢ involved in the configuration operation is the last Floorn in the floor list, and if it is the last one, the configuration process ends, otherwise it returns to step 101 to configure the call-out unit HBᵢ₊₁ for the next Floorᵢ₊₁ in the floor list.

FIG. 2 is a flowchart of a method for updating configuration information based on response messages in accordance with some other embodiments of the present application. The method described in FIG. 2 may be used to implement step 103 of FIG. 1. In this embodiment, it is assumed that the type of the identification in the response message is the identification assigned to the corresponding call-out unit.

Referring to FIG. 2, at step 201, the control apparatus determines whether the response message from the call-out unit contains the identification of the call-out unit. Exemplarily, the following description uses the call-out unit HBᵢ of i-th floor as an example. If the response message of the call-out unit HBᵢ contains the identification, the process shown in FIG. 2 proceeds to step 202, otherwise it proceeds to step 203.

In step 202, the control apparatus updates the identification of this call-out unit in the binding relationship with the identification contained in the response message. Taking Table 1 as an example, it is assumed that the identification in the response message is Aj′, the identification in row j of Table 1 will be modified from Aj to Aj′, as shown in Table 3.

TABLE 3

| Table Item | Floor | Identification |
|---|---|---|
| 1 | 5 | A1 |
| 2 | X | A2 |
| . . . | . . . | . . . |
| j | i | Aj^{′} |
| . . . | . . . | . . . |
| m | X | Am |

In another branch step 203 of step 201, since the response message from the call-out unit HBi does not contain the identification, the control apparatus will select the identification from the configuration information list that is in an unoccupied state to assign to the call-out unit HBᵢ.

Table 4 illustrates an exemplary state of the configuration information list prior to assigning the identification to the call-out unit HBᵢ. Exemplarily, it is assumed here that the identification Aj is in an unoccupied state.

TABLE 4

| Table Item | Floor | Identification |
|---|---|---|
| 1 | 5 | A1 |
| 2 | X | A2 |
| . . . | . . . | . . . |
| j | X | Aj |
| . . . | . . . | . . . |
| m | X | Am |

After step 203, the method flow shown in FIG. 2 proceeds to step 204. In this step, it is assumed that the identification Aj is assigned to the call-out unit HBᵢ, so the control apparatus saves the binding relationship between the floor i to which the call-out unit HBᵢ belongs and the identification as assigned Aj in the configuration information list.

Table 5 illustrates an exemplary state of the updated configuration information list. As shown in Table 5, the floor in the row where the identification Aj is located has been modified from “X” to “i”.

TABLE 5

| Table Item | Floor | Identification |
|---|---|---|
| 1 | 5 | A1 |
| 2 | X | A2 |
| . . . | . . . | . . . |
| j | i | Aj |
| . . . | . . . | . . . |
| m | X | Am |

This is followed by step 205, where the control apparatus returns the identification as assigned Aj to the call-out unit HBᵢ.

After steps 202 and 205, the method flow shown in FIG. 2 will, for example, go to step 105 in FIG. 1.

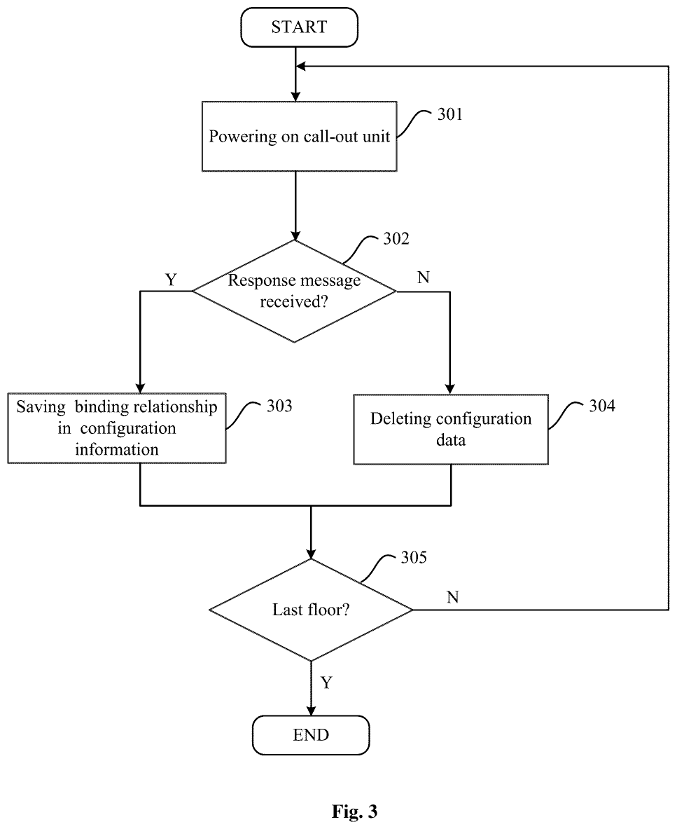

FIG. 3 is a flowchart of a method for managing call-out units in accordance with some other embodiments of the present application. The method described below may be implemented by various control apparatuses that include, for example, but are not limited to, elevator controllers and other computing devices different from elevator controllers (e.g., portable computers and cell phones, etc.), etc.

Referring to FIG. 3, in step 301, the control apparatus selects the call-out unit HBᵢ of the i-th floor Floorᵢ from a list of floors to be configured {Floorᵢ|i=1, 2 n} according to a preset floor order (e.g., from bottom to top) to power on. As described above, each call-out unit may be configured to automatically return the response message to the control apparatus upon each power-up, the response message may always contain the device identification about the call-out unit.

Subsequently, in step 302, the control apparatus determines whether the response message returned by the call-out unit HBᵢ is received. Exemplarily, the control apparatus determines whether the response message is received within a preset time period starting from power-on. If the response message is received, the configuration process shown in FIG. 3 proceeds to step 303, otherwise it proceeds to step 304.

In step 303, the control apparatus will save in the configuration information the binding relationship between the device identification contained in the response message and the i-th floor.

In this embodiment, the configuration information stored at the control apparatus contains the binding relationship between the call-out unit and the corresponding floor. Exemplarily, the configuration information represents the binding relationship in the form of a list, for example, as shown in Table 6.

TABLE 6

| | Device |
|---|---|
| Floor | identification |
| 1 | C0WJ71Y |
| 2 | E664F6A |
| . . . | . . . |
| j | 12NS8OQ |
| . . . | . . . |
| n | X |

In Table 6, each row can be used to indicate the binding relationship between the floor and the device identification, the number in column of the floor indicates the floor (e.g., “2” indicates the second floor), and the “X” in column of the device identification indicates that the floor in the row has not yet been bound with the call-out unit. Strings such as “C0WJ71Y”, “E664F6A” and “12NS8OQ” indicate the device identification of the call-out unit.

In another branch step 304 of step 302, the control apparatus releases the binding relationship between the i-th floor and the corresponding device identification by deleting the configuration data of the call-out unit HBᵢ in the configuration information (e.g., modifying the device identification of the i-th row to “X”).

After steps 303 and 304, the configuration process shown in FIG. 3 all goes to step 305, in which the control apparatus will determine whether the current floor Floorᵢ involved in the configuration operation is the last Floorn in the floor list, and if it is the last one, the configuration process ends, otherwise it returns to step 301 to configure the call-out unit HBᵢ₊₁ for the next Floorᵢ₊₁ in the floor list.

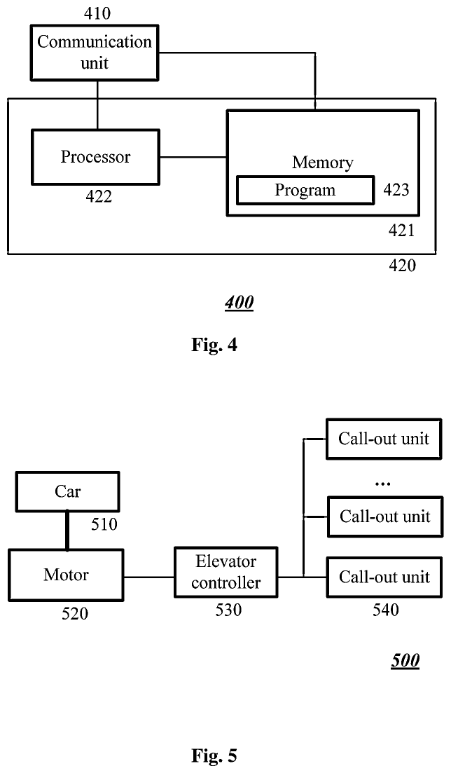

FIG. 4 is a schematic block diagram of a typical elevator controller or computing device. The elevator controller or computing device shown in FIG. 4 may be used to implement the methods shown in FIGS. 1-3.

As shown in FIG. 4, an elevator controller or computing device 400 comprises a communication unit 410 and a control unit 420. The control unit 420 comprises memory 421 (e.g., non-volatile memory such as flash memory, ROM, hard disk drive, magnetic disk, optical disc), a processor 422, and computer program 423.

The communication unit 410 serves as a communication interface configured to establish a communication connection between the elevator controller or computing device and an external device (e.g., a call-out unit) or a network (e.g., the Internet).

The memory 421 stores the computer program 423 that may be executed by the processor 422. In addition, the memory 421 may also store configuration information for the call-out unit.

The processor 422 is configured to run the computer program 423 stored on the memory 421 and to access data on the memory 421 (e.g., to query configuration information and modify configuration information, etc.).

The computer program 423 may include computer instructions for implementing the methods described with the help of FIGS. 1-3, enabling the corresponding methods to be implemented when the computer program 423 is run on the processor 422.

FIG. 5 is a schematic block diagram of a typical elevator system.

An elevator system 500 shown in FIG. 5 includes a car 510, a motor 520 for driving the movement of the car 510, an elevator controller 530, and call-out units 540 deployed on a plurality of floors.

The elevator controller 530 generates corresponding control commands based on the call request messages received from the call-out units 540, and the motor 520 controls the movement of the car 510 based on the generated control commands. In addition, the elevator controller 530 may have various features of the apparatus shown in FIG. 4, which may be configured to implement the methods shown in FIGS. 1-3.

For existing elevator controllers, automatic configuration of the call-out unit can be achieved simply by upgrading the software running therein, which is advantageous for reducing labor costs and shortening system development time.

According to another aspect of the present application, there is also provided a computer-readable storage medium on which computer program is stored. When the program is executed by the processor, one or more steps contained in the method described above with the help of FIGS. 1-3 may be realized.

The computer-readable storage medium referred in the application includes various types of computer storage medium, and may be any available medium that may be accessed by a general-purpose or special-purpose computer. For example, the computer-readable storage medium may include RAM, ROM, EPROM, E2PROM, registers, hard disks, removable disks, CD-ROM or other optical disk storage, magnetic disk storage or other magnetic storage device, or any other transitory or non-transitory medium that may be used to carry or store a desired program code unit in the form of instructions or data structures and that may be accessed by a general-purpose or special-purpose computer or a general-purpose or special-purpose processor. The above combination should also be included in the protection scope of the computer-readable storage medium. An exemplary storage medium is coupled to the processor such that the processor can read and write information from and to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

Those skilled in the art will appreciate that the various illustrative logical blocks, modules, circuits, and algorithm steps described herein may be implemented as electronic hardware, computer software, or combinations of both.

To demonstrate this interchangeability between hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. An apparatus for managing a plurality of call-out units, wherein the apparatus comprises a control unit, the control unit comprising:
a processor; and
memory coupled with the processor and storing configuration information about the plurality of call-out units and computer program capable of running on the processor,
wherein the plurality of call-out units are deployed on a plurality of floors, wherein the running of the computer program on the processor causes:
A. powering on the plurality of call-out units in sequence according to a preset floor order to cause the plurality of call-out units to return response messages containing their respective identifications in sequence; and
B. if a response message received from a call-out unit of one of the floors does not contain an identification, assigning a corresponding identification to the call-out unit and establishing a binding relationship between the floor to which the call-out unit belongs and the identification as assigned in the configuration information.

2. The apparatus of claim 1, wherein the running of the computer program further causes:
C. returning the identification as assigned to the call-out unit of one of the floors.

3. The apparatus of claim 1, wherein the running of the computer program further causes:
D. if no response message is received from the call-out unit of one of the floors and a corresponding identification exists for the floor in the configuration information, releasing a binding relationship between the floor and the corresponding identification in the configuration information.

4. The apparatus of claim 1, wherein the running of the computer program further causes:
E. if the response message received from the call-out unit of one of the floors contains the identification, establishing a binding relationship between the floor to which the call-out unit belongs and the identification contained in the response message in the configuration information.

5. The apparatus of claim 1, wherein the configuration information is presented in the form of a list, each item of the list is used to describe the binding relationship between the floor to which the call-out unit belongs and the identification of the call-out unit.

6. The apparatus of claim 1, wherein the apparatus is an elevator controller.

7. The apparatus of claim 1, wherein operation A is performed during initialization of an elevator.

8. An apparatus for managing a plurality of call-out units, wherein the apparatus comprises a control unit, the control unit comprising:
a processor; and
memory coupled with the processor and storing configuration information about the plurality of call-out units and computer program capable of running on the processor,
wherein the plurality of call-out units are deployed on a plurality of floors,
wherein the running of the computer program on the processor causes:
A′. powering on the plurality of call-out units in sequence according to a preset floor order to cause the plurality of call-out units to return response messages containing their respective device identifications in sequence; and
B′. establishing a binding relationship between the device identification contained in the corresponding response message and the floor in the configuration information for each floor.

9. The apparatus of claim 8, wherein the running of the computer program further causes:
C′. if no response message is received from the call-out unit of one of the floors and a corresponding device identification exists for the floor in the configuration information, releasing a binding relationship between the floor and the corresponding device identification in the configuration information.

10. The apparatus of claim 8, wherein the configuration information is presented in the form of a list, each item of the list is used to describe the binding relationship between the device identification of the call-out unit and the floor to which the call-out unit belongs.

11. The apparatus of claim 8, wherein the apparatus is an elevator controller.

12. The apparatus of claim 8, wherein operation A′ is performed during initialization of an elevator.

13. An elevator system comprising the apparatus as claimed in claim 1.

14. A method for managing a plurality of call-out units, wherein the plurality of call-out units are deployed on a plurality of floors, the method comprising:
A. powering on the plurality of call-out units in sequence according to a preset floor order to cause the plurality of call-out units to return response messages containing their respective identifications in sequence; and
B. if a response message received from a call-out unit of one of the floors does not contain an identification, assigning a corresponding identification to the call-out unit and establishing a binding relationship between the floor to which the call-out unit belongs and the identification as assigned in configuration information.

15. The method of claim 14, wherein further comprising:
C. returning the identification as assigned to the call-out unit of one of the floors.

16. The method of claim 14, wherein further comprising:
D. if no response message is received from the call-out unit of one of the floors and a corresponding identification exists for the floor in the configuration information, releasing a binding relationship between the floor and the corresponding identification in the configuration information.

17. The method of claim 14, wherein further comprising:
E. if the response message received from the call-out unit of one of the floors contains the identification, establishing a binding relationship between the floor to which the call-out unit belongs and the identification contained in the response message in the configuration information.

18. The method of claim 14, wherein the configuration information is presented in the form of a list, each item of the list is used to describe the binding relationship between the floor to which the call-out unit belongs and the identification of the call-out unit.

19. The method of claim 14, wherein step A is performed during initialization of an elevator.

20. A method for managing a plurality of call-out units, wherein the plurality of call-out units are deployed on a plurality of floors, the method comprising:
A′. powering on the plurality of call-out units in sequence according to a preset floor order to cause the plurality of call-out units to return response messages containing their respective device identifications in sequence; and
B′. establishing a binding relationship between the device identification contained in the corresponding response message and the floor in configuration information for each floor.

21. The method of claim 20, wherein further comprising:
C′. if no response message is received from the call-out unit of one of the floors and a corresponding device identification exists for the floor in the configuration information, releasing a binding relationship between the floor and the corresponding device identification in the configuration information.

22. The method of claim 20, wherein the configuration information is presented in the form of a list, each item of the list is used to describe the binding relationship between the device identification of the call-out unit and the floor to which the call-out unit belongs.

23. The method of claim 20, wherein step A′ is performed during initialization of an elevator.

24. A computer-readable storage medium having instructions stored in the computer-readable storage medium, when the instructions are executed by a processor, the processor is caused to execute the method of claim 14.
